(19) United States
(12) Patent Application Publication
(10) Pub. No.: US 2026/0320880 A1
(43) Pub. Date: Oct. 15, 2026

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Junichi OKADA, Tokyo (JP)

(73) Assignee: FUJIFILM Corporation, Tokyo (JP)

(21) Appl. No.: 19/467,870

(22) Filed: Feb. 3, 2026

(30) Foreign Application Priority Data
Mar. 10, 2025 (JP) 2025-037522

(51) Int. Cl. G06T 12/00; G06T 5/73; G06T 7/20

(52) U.S. Cl. CPC G06T 12/00; G06T 5/73; G06T 7/20; G06T 2207/10081; G06T 2207/30004; G06T 2210/41; G06T 2211/40

(57) ABSTRACT

An image processing apparatus acquires a first deflection amount of a subject in a body axis direction and a second deflection amount in a cross direction intersecting the body axis direction, the first deflection amount and the second deflection amount being a deflection amount of a table on which the subject lies, and generates a radiographic image corrected using the first deflection amount and the second deflection amount, the radiographic image being obtained by irradiating the subject with radiation.

### CROSS-REFERENCE TO RELATED APPLICATION

This application claims priority from Japanese Patent Application No. 2025-037522, filed on Mar. 10, 2025, the entire disclosure of which is incorporated herein by reference.

### BACKGROUND

### 1. Technical Field

The present disclosure relates to an image processing apparatus, an image processing method, and an image processing program.

### 2. Description of the Related Art

JP2017-060550A discloses a technique of correcting an X-ray image based on a deflection amount of a table on which a subject lies in a body axis direction of the subject.

### SUMMARY

However, in the technique disclosed in JP2017-060550A, since only the deflection of the table in the body axis direction of the subject is considered, there is room for improvement in terms of image quality of the radiographic image.

The present disclosure has been made in view of the above circumstances, and an object thereof is to provide an image processing apparatus, an image processing method, and an image processing program capable of suppressing a decrease in image quality of a radiographic image.

An image processing apparatus according to the technique of the present disclosure includes a processor,
in which the processor is configured to:
   acquire a first deflection amount of a subject in a body axis direction and a second deflection amount in a cross direction intersecting the body axis direction, the first deflection amount and the second deflection amount being a deflection amount of a table on which the subject lies; and
   generate a radiographic image corrected using the first deflection amount and the second deflection amount, the radiographic image being obtained by irradiating the subject with radiation.

In an image processing method according to the technique of the present disclosure, a processor included in an image processing apparatus is configured to execute the image processing method including:
acquiring a first deflection amount of a subject in a body axis direction and a second deflection amount in a cross direction intersecting the body axis direction, the first deflection amount and the second deflection amount being a deflection amount of a table on which the subject lies; and
generating a radiographic image corrected using the first deflection amount and the second deflection amount, the radiographic image being obtained by irradiating the subject with radiation.

An image processing program according to the technique of the present disclosure causes a processor included in an image processing apparatus to execute a process of:
acquiring a first deflection amount of a subject in a body axis direction and a second deflection amount in a cross direction intersecting the body axis direction, the first deflection amount and the second deflection amount being a deflection amount of a table on which the subject lies; and
generating a radiographic image corrected using the first deflection amount and the second deflection amount, the radiographic image being obtained by irradiating the subject with radiation.

According to the present disclosure, a decrease in image quality of a radiographic image can be suppressed.

### BRIEF DESCRIPTION OF THE DRAWINGS

FIG. 1 is a perspective view showing a schematic configuration of a tomographic imaging system.

FIG. 2 is a front view showing a schematic configuration of the tomographic imaging system.

FIG. 3 is a side view for describing a first deflection amount.

FIG. 4 is a side view for describing a first deflection amount according to a modification example.

FIG. 5 is a front view for describing a second deflection amount.

FIG. 6 is a front view for describing a second deflection amount according to the modification example.

FIG. 7 is a side view for describing a deflection amount measurement device according to the modification example.

FIG. 8 is a block diagram showing an example of a hardware configuration of a console.

FIG. 9 is a block diagram showing an example of a functional configuration of the console.

FIG. 10 is a diagram showing an example of a display screen of a CT image.

FIG. 11 is a diagram showing an example of the display screen of the CT image.

FIG. 12 is a flowchart showing an example of CT image capture processing.

### DETAILED DESCRIPTION

Hereinafter an embodiment for carrying out the present disclosed technology will be described in detail with reference to the accompanying drawings.

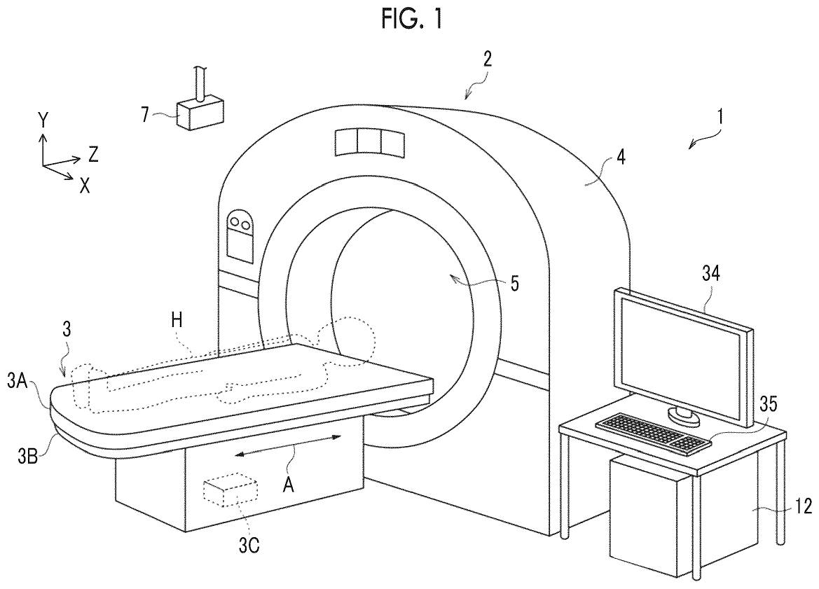

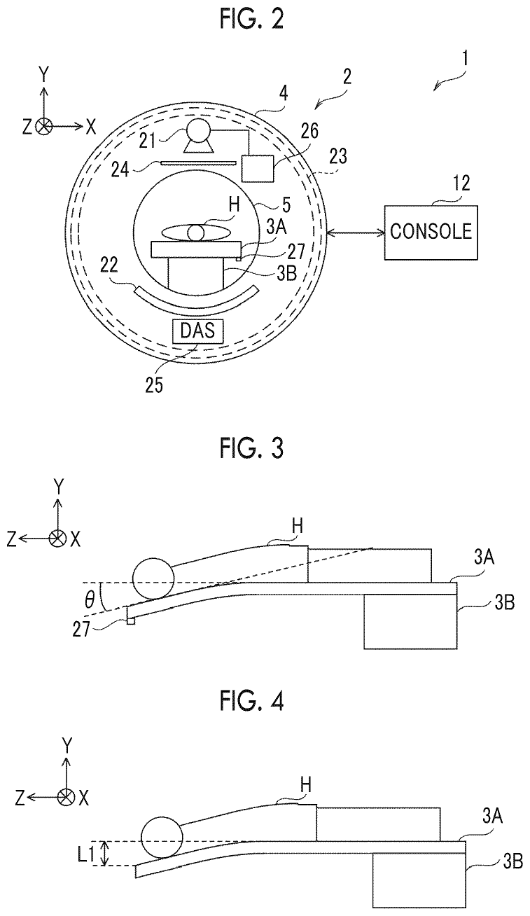

First, a configuration of a tomographic imaging system 1 will be described with reference to FIGS. 1 and 2. As shown in FIG. 1, the tomographic imaging system 1 according to the present embodiment comprises a CT apparatus 2 and a console 12. The CT apparatus 2 captures a CT image including a plurality of tomographic images of a subject H by imaging the subject H using X-rays, which are an example of radiation. The CT image is an example of a radiographic image obtained by irradiating the subject H with radiation.

The CT apparatus 2 comprises a table device 3 and a gantry 4. The table device 3 comprises a table 3A on which the subject H lies, a support part 3B that supports the table 3A, and a driving part 3C that reciprocates the table 3A in an arrow A direction. The table 3A is a substantially rectangular plate-shaped member. Hereinafter, a body axis direction of the subject H lying on the table 3A will be defined as a Z-axis direction, a width direction of the subject H, which is a cross direction intersecting the body axis direction (orthogonal in the present embodiment), will be defined as an X-axis direction, and a vertical direction will be defined as a Y-axis direction. The Z-axis direction is a longitudinal direction of the table 3A and the arrow A direction, and the X-axis direction is a lateral direction of the table 3A. The gantry 4 has an annular shape as a whole, and a circular opening part 5 having a diameter greater than a width of the table 3A is formed in the center. During capturing the CT image, the table 3A on which the subject H lies moves in the Z-axis direction relative to the gantry 4, thereby entering the opening part 5. The imaging is performed while moving the table 3A relative to the gantry 4.

A camera 7 is installed on a ceiling above the table device 3. The camera 7 is a camera that can capture a color image of red (R), green (G), and blue (B) by detecting reflected light of the subject H. The camera 7 includes an imaging element such as a lens and a charge coupled device (CCD), and acquires a camera image, which is a moving image, by imaging the subject H on the table 3A at a predetermined frame rate and outputs the visible light image to the console 12. The camera 7 may be a camera in which an RGB camera and a near infrared (NIR) camera are integrated. In this case, the NIR camera is a stereo camera, and information in the Y-axis direction of the subject H can be acquired by parallax. By setting the NIR camera of the camera 7 as the stereo camera, information in the Y-axis direction of the subject H on the table device 3 can be acquired. The NIR camera can perform capturing even in a case where an amount of light is insufficient. Therefore, in a case where the brightness of the examination room is insufficient for capturing of the RGB camera, the subject H may be imaged in the Y-axis direction by the NIR camera. Additionally, the camera 7 may be provided on a wall surface, a housing of the gantry 4, or the like instead of on the ceiling. Further, the camera 7 may be provided at each of a plurality of locations.

As shown in FIG. 2, a radiation source 21, a radiation detector 22, and a frame 23 are disposed inside the gantry 4. The radiation source 21 emits radiation toward the subject H. The radiation detector 22 detects radiation transmitted through the subject H. The radiation transmitted through the subject H is attenuated by interaction (for example, absorption and scattering of the radiation) with structures such as organs and bones in the body of the subject H. The structures each have an attenuation coefficient for radiation peculiar to the structures, and the radiation transmitted through the structures carries information reflecting the physical properties of the structures. The radiation detector 22 detects radiation in which physical properties of the structures in the body of the subject H are reflected. The radiation detector 22 has a detection surface in which detection elements are two-dimensionally arranged, and outputs a detection signal for each detection element. Therefore, the radiation detector 22 can detect the radiation at each transmission position transmitted through the structure of the subject H. In addition, the radiation detector 22 has a substantially arc shape in accordance with a curvature of the gantry 4, and the detection surface is also curved. The radiation detector 22 is an example of a photon counting type radiation detector, and is a radiation detector that can count the number of photons of incident radiation. That is, the CT apparatus 2 is a photon counting computed tomography (PCCT) device.

The radiation source 21 and the radiation detector 22 are disposed at positions facing each other in the gantry 4 and are rotated about the Z axis while maintaining the facing posture. The frame 23 has an annular shape and supports the radiation source 21 and the radiation detector 22 to be rotatable. In imaging, the gantry 4 acquires detection signals by the radiation detector 22 at a plurality of positions in a circumferential direction about the Z axis corresponding to a body axis of the subject H while rotating the radiation source 21 and the radiation detector 22 about the subject H on the table 3A. In the imaging, the table 3A is also moved in the Z-axis direction in synchronization with the rotation of the radiation source 21 and the radiation detector 22.

A data acquisition system (DAS) 25 collects the detection signal output by the radiation detector 22, generates output data at each position around the Z axis based on the collected detection signal, and outputs the generated output data to the console 12. In a case where the subject H is present between the radiation source 21 and the radiation detector 22, this output data is projection data in which the subject H is projected.

An irradiation field limiter 24 (also referred to as a collimator) that limits an irradiation field of the radiation is disposed in front of the radiation source 21 in an irradiation direction. The irradiation field limiter 24 has an irradiation opening of which a contour is defined by a plurality of shielding plates that shield the radiation, and a size of the irradiation opening can be changed by moving the shielding plates. A voltage is supplied to the radiation source 21 from a high-voltage generator 26. The radiation source 21 and the radiation detector 22 are electrically connected to the frame 23 by a slip ring method, and, for example, power supply, transmission and reception of data, and the like are performed via the slip ring. The slip ring method connection makes it possible to perform helical scan imaging in which the radiation source 21 and the radiation detector 22 are rotated in one direction while performing imaging without reversing the rotation direction.

The console 12 controls the radiation source 21 and the radiation detector 22 via a control device (not shown) provided in the gantry 4. The console 12 is an example of an image processing apparatus according to the disclosed technology. Imaging conditions of the CT apparatus 2 are set via the operation from the console 12. The imaging condition includes irradiation conditions of the radiation source 21, an imaging range, and the like. The irradiation condition of the radiation includes a tube voltage (unit: kV) applied to the radiation source 21, a tube current (unit: mA), and an irradiation time (unit: msec) of the radiation. The imaging range is adjusted, for example, by changing the size of the irradiation opening of the irradiation field limiter 24 in the X-Z plane, and is adjusted by changing a movement range of the table 3A in the Z-axis direction.

An angle meter 27 is provided at an end part of the table 3A on the radiation source 21 side (that is, a gantry 4 side) in the Z-axis direction and at an end part (in the example of FIG. 2, a right end part) in the X-axis direction. Examples of the angle meter 27 include a digital angle meter. The angle meter 27 measures a deflection amount of the table 3A in the Z-axis direction (hereinafter, referred to as a “first deflection amount”) and a deflection amount of the table 3A in the X-axis direction (hereinafter, referred to as a “second deflection amount”).

As shown in FIG. 3, in the present embodiment, a case where an angle θ between the Z-axis direction and a planar direction of a deflection portion of the table 3A is applied as the first deflection amount will be described as an example. As shown in FIG. 4, as the first deflection amount, a distance L1 along the Y-axis direction between a non-deflected portion of the table 3A and a predetermined position (in the example of FIG. 4, a position of a distal end) of the deflection portion may be applied.

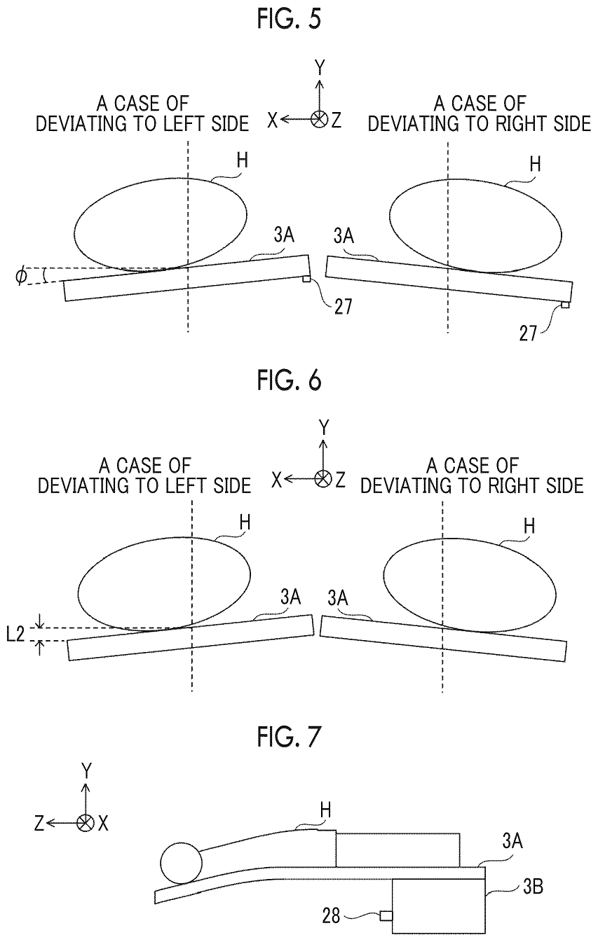

As shown in FIG. 5, the table 3A also deflects in the X-axis direction in a case where a position of subject H deviates to either the left or the right from a center in the X-axis direction. As shown in FIG. 5, in the present embodiment, a case where an angle φ between the X-axis direction and a planar direction of a deflection portion of the table 3A is applied as the second deflection amount will be described as an example. As shown in FIG. 6, as the second deflection amount, a distance L2 along the Y-axis direction between a non-deflected portion of the table 3A (in the example of FIG. 6, the center in the X-axis direction) and a predetermined position (in the example of FIG. 6, a position of a left end part) of the deflection portion may be applied.

In addition, a device that measures the first deflection amount and the second deflection amount is not limited to the angle meter 27. For example, as shown in FIG. 7, the device that measures the first deflection amount and the second deflection amount may be a laser measuring instrument 28 provided at a position of the support part 3B of the table 3A on the radiation source 21 side (that is, the gantry 4 side) and at a position below the table 3A.

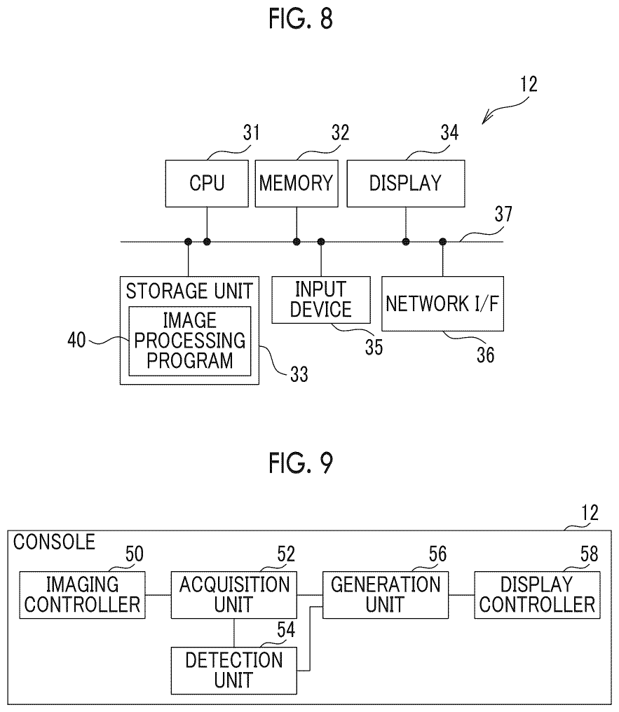

Subsequently, a hardware configuration of the console 12 according to the present embodiment will be described with reference to FIG. 8. Examples of the console 12 include a computer, such as a personal computer or a server computer. As shown in FIG. 8, the console 12 includes a central processing unit (CPU) 31, a memory 32 as a temporary storage area, and a non-volatile storage unit 33. In addition, the console 12 includes a display 34 such as a liquid crystal display, an input device 35 such as a keyboard and a mouse, and a network interface (I/F) 36. The CPU 31, the memory 32, the storage unit 33, the display 34, the input device 35, and the network I/F 36 are connected to a bus 37. The CPU 31 is an example of a processor according to the disclosed technology. The CPU 31 communicates with the CT apparatus 2 and the angle meter 27 via the network I/F 36.

The storage unit 33 is implemented using a hard disk drive (HDD), a solid state drive (SSD), a flash memory, or the like. The storage unit 33 as a storage medium stores an image processing program 40. The CPU 31 reads out the image processing program 40 from the storage unit 33, loads the image processing program 40 in the memory 32, and executes the loaded image processing program 40.

As described above, since the CT apparatus 2 according to the present embodiment is the PCCT apparatus, a high-definition CT image can be captured as compared to a CT apparatus comprising an energy-integrating type radiation detector. The second deflection amount is smaller than the first deflection amount, but may cause a decrease in image quality in the high-definition CT image. Therefore, the console 12 according to the present embodiment has a function of generating a CT image in which distortion of an image caused by the first deflection amount and the second deflection amount is corrected.

A functional configuration of the console 12 will be described with reference to FIG. 9. As shown in FIG. 9, the console 12 includes an imaging controller 50, an acquisition unit 52, a detection unit 54, a generation unit 56, and a display controller 58. The CPU 31 executes the image processing program 40 to function as the imaging controller 50, the acquisition unit 52, the detection unit 54, the generation unit 56, and the display controller 58.

In a case where an instruction to start imaging in the CT apparatus 2 is received, the imaging controller 50 starts irradiation with radiation and performs control of capturing the CT image of the subject H by the helical scanning method according to the imaging conditions. The instruction to start imaging is input by, for example, the user via the input device 35.

The acquisition unit 52 sequentially acquires a plurality of pieces of projection data output from the DAS 25 under the control of the imaging controller 50. In addition, the acquisition unit 52 acquires the first deflection amount and the second deflection amount measured by the angle meter 27. In the present embodiment, the acquisition unit 52 sequentially acquires the first deflection amount and the second deflection amount each time the table 3A moves forward by a distance set in advance in the Z-axis direction during the irradiation with radiation under the control of the imaging controller 50. That is, the projection data is associated with the first deflection amount and the second deflection amount at a time point at which the projection data is acquired.

The detection unit 54 detects whether or not a change amount of at least one of the first deflection amount or the second deflection amount is equal to or greater than a threshold value during the irradiation with radiation to the subject H under the control of the imaging controller 50. This is performed to detect a body movement of the subject H during imaging. The change amount in this case may be, for example, a change amount based on an initial first deflection amount and second deflection amount at a time point of start of imaging, or a change amount based on the first deflection amount and the second deflection amount acquired before a predetermined time during imaging. In addition, the threshold value in this case is set in advance by an experiment or the like.

The generation unit 56 generates the CT image by performing reconstruction of the image based on the plurality of pieces of projection data acquired by the acquisition unit 52. The image reconstruction is performed by, for example, a filtered back projection method. In this case, the generation unit 56 generates the CT image in which the distortion of the image caused by the first deflection amount and the second deflection amount is corrected by using the first deflection amount and the second deflection amount acquired by the acquisition unit 52. Hereinafter, the correction process of the image using the first deflection amount and the second deflection amount will be referred to as “first correction process”.

A specific example of the first correction process will be described. Here, it is assumed that the program for performing the image reconstruction is performed on the premise that the subject H is positioned at the center of the opening part 5. The generation unit 56 derives a deviation amount representing how much the subject H is deviated from the center of the opening part 5 in a case of acquiring each of the plurality of pieces of projection data by using the first deflection amount and the second deflection amount. Then, in a case of performing the image reconstruction based on the plurality of pieces of projection data, the generation unit 56 generates the CT image corrected as if the subject H is positioned at the center of the opening part 5 by using the deviation amount.

The generation unit 56 may generate the CT image by performing the image reconstruction based on the plurality of pieces of projection data as the first correction process, and then correct the CT image by using the first deflection amount and the second deflection amount. In this case, for example, the generation unit 56 may correct the CT image by performing a projective transformation based on the first deflection amount and the second deflection amount.

In addition, in a case where the detection unit 54 detects that the change amount is equal to or greater than the threshold value, the generation unit 56 generates the CT image in which the second correction process of correcting the shake caused by the body movement of the subject H is performed in addition to the first correction process. A known body movement correction algorithm for the CT image can be applied to the second correction process.

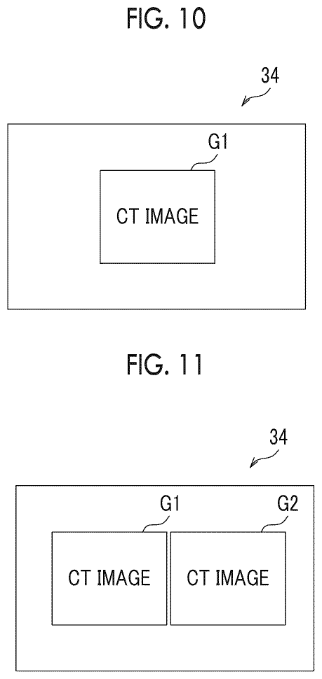

The display controller 58 performs control of displaying the CT image generated by the generation unit 56 on the display 34. In the present embodiment, as shown in FIG. 10 as an example, in a case where the detection unit 54 does not detect that the change amount is equal to or greater than the threshold value, the display controller 58 performs control of displaying a CT image G1 in which the first correction process is performed on the display 34. On the other hand, as shown in FIG. 11 as an example, in a case where the detection unit 54 detects that the change amount is equal to or greater than the threshold value, the display controller 58 performs control of displaying a CT image G1 in which only the first correction process is performed among the first correction process and the second correction process and a CT image G2 in which the first correction process and the second correction process are performed side by side on the display 34.

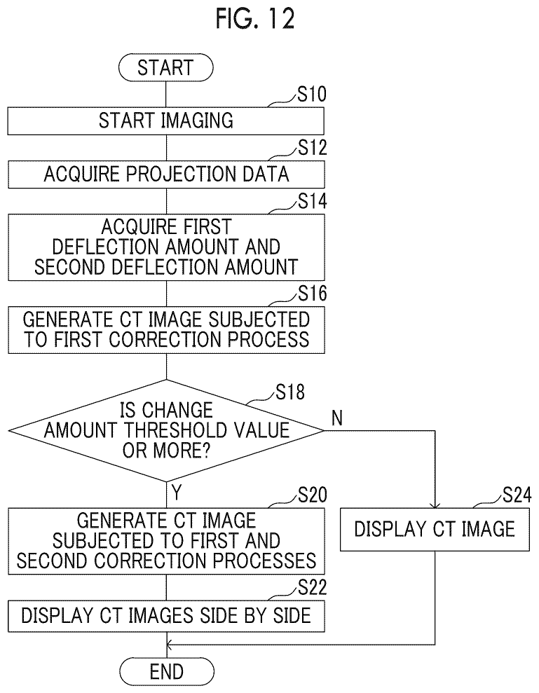

Subsequently, the operation and effect of the console 12 will be described with reference to FIG. 12. The CPU 31 executes the image processing program 40 to execute CT image capture processing shown in FIG. 12. The CT image capturing processing is executed, for example, in a case where the instruction to start imaging is input by the user.

In step S10 of FIG. 12, the imaging controller 50 starts irradiation with radiation and performs control of capturing the CT image of the subject H by the helical scanning method according to the imaging conditions. In step S12, the acquisition unit 52 sequentially acquires the plurality of pieces of projection data output from the DAS 25 under the control of step S10. In step S14, the acquisition unit 52 sequentially acquires the first deflection amount and the second deflection amount measured by the angle meter 27.

In step S16, as described above, the generation unit 56 generates the CT image in which the first correction process using the first deflection amount and the second deflection amount is performed. In step S18, the detection unit 54 determines whether or not the change amount of at least one of the first deflection amount or the second deflection amount is equal to or greater than the threshold value during the irradiation with radiation to the subject H. In a case where this determination results in an affirmative determination, the processing transitions to step S20.

In step S20, as described above, the generation unit 56 generates the CT image in which the second correction process of correcting the shake caused by the body movement of the subject H is performed in addition to the first correction process. In step S22, the display controller 58 performs control of displaying the CT image generated in step S16 and the CT image generated in step S20 side by side on the display 34. In a case where the processing of step S22 is ended, the CT image capture processing is ended.

Meanwhile, in a case where the determination in step S18 results in a negative determination, the processing transitions to step S24. In step S24, the display controller 58 performs control of displaying the CT image generated in step S16 on the display 34. In a case where the processing of step S24 is ended, the CT image capture processing is ended.

As described above, according to the present embodiment, the CT image corrected by using both the first deflection amount and the second deflection amount is generated. Therefore, a decrease in image quality of the CT image caused by the deflection of the table 3A can be suppressed as compared to a case where only the first deflection amount is used.

In the above-described embodiment, in a case where the second deflection amount is equal to or greater than the threshold value in a case of capturing a scanogram performed to determine the imaging range of the subject H, the CPU 31 may notify information for prompting the subject H to change the positioning. Examples of the information in this case include a message for notifying that the position of the subject H is deviated from the center. In addition, as the notification in this case, the CPU 31 may perform control of displaying text representing the information on the display 34, or may perform control of outputting a voice representing the information from a voice output device such as a speaker.

In addition, in the above-described embodiment, a case where the radiation detector 22 is a photon counting type radiation detector has been described, but the disclosed technology is not limited to this aspect. For example, the radiation detector 22 may be an energy-integrating type radiation detector that converts radiation into visible light and then accumulates charges generated by converting the visible light into an electric signal for a certain time.

In addition, in the above-described embodiment, a case where the radiographic image is the CT image captured by the CT apparatus 2 has been described, but the disclosed technology is not limited to this aspect. For example, the radiographic image may be a radiographic image captured by a C-arm type radiography apparatus.

Furthermore, at least one of the functional units provided in the console 12 in the above embodiment may be provided in another device, such as a control device provided in the gantry 4.

In addition, in the above-described embodiment, each process is executed by any computer. Moreover, any computer may execute these processes by a processor as hardware, a program as software, or a combination thereof. In such a case, the processor is configured to execute various types of processing in the above-described embodiment in cooperation with the program, and may function as each unit or each means in the above-described embodiment. Further, the execution order of the processing by the processor is not limited to the above-described order and may be changed as appropriate. Any computer may be a general-purpose computer, a computer for specific use, a workstation, or another system capable of executing each processing.

The processor may be composed of one or a plurality of pieces of hardware, and types of hardware are not limited. For example, the processor may be configured with hardware such as a central processing unit (CPU), a micro processing unit (MPU), a programmable logic device such as a field-programmable gate array (FPGA), a dedicated circuit for executing specific processing such as an application-specific integrated circuit (ASIC), a graphic processing unit (GPU), or a neural processing unit (NPU). Additionally, the types of hardware may be a combination of different types of hardware. In a case where the plurality of types of hardware are configured to execute one or a plurality of types of processing of a certain processor, the plurality of types of hardware may exist in devices physically separated from each other or may exist in the same device. Furthermore, in any of the embodiments, the order of each processing performed by the processor is not limited to the above-described order, and may be changed as appropriate. The hardware is composed of an electric circuit (circuitry) in which circuit elements such as semiconductor elements are combined.

The program may be software such as firmware or a microcode. Furthermore, the program may be, for example, a program module group, and each function thereof may be implemented by a processor configured to execute each function. The program may be a program code or a plurality of code segments stored in one or a plurality of non-transitory computer-readable media (for example, a storage medium and other storages). The program may be stored in the plurality of non-transitory computer-readable media existing in physically separated devices. The program code or the code segment may represent any combination of procedures, functions, subprograms, routines, subroutines, modules, software packages, classes, instructions, data structures, or program statements. The program code or the code segments may be connected to other code segments or hardware circuits by transmitting and receiving information, data, an argument, a parameter, or content of a memory.

In the above embodiment, the image processing program 40 is described as being stored (installed) in the storage unit 33 in advance; however, the present disclosure is not limited thereto. The image processing program 40 may be provided in a form recorded in a recording medium such as a compact disc read-only memory (CD-ROM), a digital versatile disc read-only memory (DVD-ROM), and a universal serial bus (USB) memory. Further, the image processing program 40 may also be downloaded from an external device via the network. In addition, the image processing program 40 can be provided as a program product. The program product includes products in all aspects for providing a program. For example, the program product includes a program provided through a network such as the Internet, and a non-transitory computer readable recording medium such as a CD-ROM or a DVD in which the program is stored.

In regard to the above-described embodiment, the supplementary notes will be further disclosed as follows.

### Supplementary Note 1

An image processing apparatus comprising a processor,
in which the processor is configured to:
   acquire a first deflection amount of a subject in a body axis direction and a second deflection amount in a cross direction intersecting the body axis direction, the first deflection amount and the second deflection amount being a deflection amount of a table on which the subject lies; and
   generate a radiographic image corrected using the first deflection amount and the second deflection amount, the radiographic image being obtained by irradiating the subject with radiation.

### Supplementary Note 2

The image processing apparatus according to Supplementary Note 1,
in which the processor is configured to generate a radiographic image subjected to a second correction process of correcting a shake caused by a body movement of the subject in addition to a first correction process using the first deflection amount and the second deflection amount, in a case where detection is made that a change amount of at least one of the first deflection amount or the second deflection amount is equal to or greater than a threshold value during the irradiation with radiation to the subject.

### Supplementary Note 3

The image processing apparatus according to Supplementary Note 2,
in which the processor is configured to perform control to display, side by side, a radiographic image subjected only to the first correction process between the first correction process and the second correction process, and a radiographic image subjected to both the first correction process and the second correction process.

### Supplementary Note 4

The image processing apparatus according to any one of Supplementary Notes 1 to 3,
in which the processor is configured to provide notification information prompting a change in positioning of the subject in a case where the second deflection amount is equal to or greater than a threshold value.

### Supplementary Note 5

The image processing apparatus according to any one of Supplementary Notes 1 to 4,
in which the processor is configured to acquire the first deflection amount and the second deflection amount measured by an angle meter provided at an end part of the table, the end part being on a radiation source side in the body axis direction and being at an end part in the cross direction.

### Supplementary Note 6

The image processing apparatus according to any one of Supplementary Notes 1 to 4,
in which the processor is configured to acquire the first deflection amount and the second deflection amount measured by a laser measuring instrument provided at a position in a support part of the table, the position being on a radiation source side and below the table.

### Supplementary Note 7

The image processing apparatus according to any one of Supplementary Notes 1 to 6,
in which the radiographic image is a CT image.

### Supplementary Note 8

The image processing apparatus according to Supplementary Note 7,
in which the CT image is an image captured by a CT apparatus including a photon counting type radiation detector.

### Supplementary Note 9

An image processing method executed by a processor included in an image processing apparatus, the image processing method comprising:
acquiring a first deflection amount of a subject in a body axis direction and a second deflection amount in a cross direction intersecting the body axis direction, the first deflection amount and the second deflection amount being a deflection amount of a table on which the subject lies; and
generating a radiographic image corrected using the first deflection amount and the second deflection amount, the radiographic image being obtained by irradiating the subject with radiation.

### Supplementary Note 10

An image processing program causing a processor included in an image processing apparatus to execute a process of:
acquiring a first deflection amount of a subject in a body axis direction and a second deflection amount in a cross direction intersecting the body axis direction, the first deflection amount and the second deflection amount being a deflection amount of a table on which the subject lies; and
generating a radiographic image corrected using the first deflection amount and the second deflection amount, the radiographic image being obtained by irradiating the subject with radiation.

What is claimed is:

1. An image processing apparatus comprising a processor,
wherein the processor is configured to:
acquire a first deflection amount of a subject in a body axis direction and a second deflection amount in a cross direction intersecting the body axis direction, the first deflection amount and the second deflection amount being a deflection amount of a table on which the subject lies; and
generate a radiographic image corrected using the first deflection amount and the second deflection amount, the radiographic image being obtained by irradiating the subject with radiation.

2. The image processing apparatus according to claim 1,
wherein the processor is configured to generate a radiographic image subjected to a second correction process of correcting a shake caused by a body movement of the subject in addition to a first correction process using the first deflection amount and the second deflection amount, in a case where detection is made that a change amount of at least one of the first deflection amount or the second deflection amount is equal to or greater than a threshold value during the irradiation with radiation to the subject.

3. The image processing apparatus according to claim 2,
wherein the processor is configured to perform control to display, side by side, a radiographic image subjected only to the first correction process between the first correction process and the second correction process, and a radiographic image subjected to both the first correction process and the second correction process.

4. The image processing apparatus according to claim 1,
wherein the processor is configured to provide notification information prompting a change in positioning of the subject in a case where the second deflection amount is equal to or greater than a threshold value.

5. The image processing apparatus according to claim 1,
wherein the processor is configured to acquire the first deflection amount and the second deflection amount measured by an angle meter provided at an end part of the table, the end part being on a radiation source side in the body axis direction and being at an end part in the cross direction.

6. The image processing apparatus according to claim 1,
wherein the processor is configured to acquire the first deflection amount and the second deflection amount measured by a laser measuring instrument provided at a position in a support part of the table, the position being on a radiation source side and below the table.

7. The image processing apparatus according to claim 1,
wherein the radiographic image is a CT image.

8. The image processing apparatus according to claim 7,
wherein the CT image is an image captured by a CT apparatus including a photon counting type radiation detector.

9. An image processing method executed by a processor included in an image processing apparatus, the image processing method comprising:
acquiring a first deflection amount of a subject in a body axis direction and a second deflection amount in a cross direction intersecting the body axis direction, the first deflection amount and the second deflection amount being a deflection amount of a table on which the subject lies; and
generating a radiographic image corrected using the first deflection amount and the second deflection amount, the radiographic image being obtained by irradiating the subject with radiation.

10. A non-transitory computer-readable storage medium storing an image processing program causing a processor included in an image processing apparatus to execute a process of:
acquiring a first deflection amount of a subject in a body axis direction and a second deflection amount in a cross direction intersecting the body axis direction, the first deflection amount and the second deflection amount being a deflection amount of a table on which the subject lies; and
generating a radiographic image corrected using the first deflection amount and the second deflection amount, the radiographic image being obtained by irradiating the subject with radiation.
